(19) United States
(12) Patent Application Publication
(10) Pub. No.: US 2008/0022274 A1
(43) Pub. Date: Jan. 24, 2008

(54) Method and system for pre-installation conflict identification and prevention

(76) Inventor: Johnny M. Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/408,342

(22) Filed: Apr. 22, 2006

(51) Int. Cl. G06F 9/445

(52) U.S. Cl. 717/174

(57) ABSTRACT

A system, method and computer program product for performing pre-installation conflict identification and prevention are disclosed. The method includes, in response to determining that a user wants to perform a conflict check for the application for the installation, contacting a remote server over a secure connection across a network and determining whether a problem history exists on the remote server for the identified application. One or more items of relevant information about the data processing system are transmitted to the remote server over the secure connection across the network and pre-installation conflict identification is performed by receiving a percentage risk of an install failure of the installation. The percentage risk of the install failure of the installation is displayed to the user, and, in response to the user indicating a desire to continue an installation in spite of the percentage risk of the install failure of the installation, performing the installation. Conflict prevention is performed by recommending upgrades prior to the installation and installing the upgrades.

### BACKGROUND OF THE INVENTION

1. Technical Field

The present invention relates in general to data processing systems and in particular to software installation. Still more particularly, the present invention relates to a system, method and computer program product for performing pre-installation conflict identification and prevention for an application for an installation on a data processing system.

2. Description of the Related Art

In computing, the frustrations associated with the installation of new software on a data processing system frequent include the management of conflicts between versions of software. The frustrations are so great and so time consuming that practitioners in the art have invested tremendous resources in diagnosing, describing, and fixing conflict issues. “Dependency hell”, for example, is a colloquial term for the frustration of many users who have installed Linux software packages which have dependencies on specific versions of other packages and resulting conflicts with other versions of software packages. Even if the version is newer than the one being requested by the installing software, it may present conflicts, and package managers like RPM and Dpkg will refuse to install. Although most package managers can be forced to install packages with options such as—nodeps or—force-depends, these can often lead to worse problems than those they were intended to solve.

Because different pieces of software have different dependencies (the most common being different compiler versions), this problem of conflicts often leads to a conflict between the software that is required and the software that is installed. It is possible to get into a vicious circle of dependency requirements, or (possibly worse) an ever-expanding tree of requirements as each new package demands several more be installed.

In a Windows environment, conflicts problems are commonly referred to as DLL Hell. DLL Hell encompasses the difficulties of managing Microsoft's Dynamic Link Libraries (DLLs). These difficulties include conflicts between DLL versions, difficulty in obtaining required DLLs, and having many unnecessary DLL copies. DLL Hell is an example of a latent operating system (OS) flaw—that is, problems occur in well written programs because of bad programming practice or a bug in poorly written software that is tolerated by the OS. The canonical example of a latent OS flaw is time slicing in Microsoft operating systems before Windows NT and XP. With time slicing, a rogue or buggy program can effectively disable the entire computer, forcing the user to hard boot the machine.

While many solutions to conflicts problems have been proposed, none has proven adequate.

### SUMMARY OF THE INVENTION

A system, method and computer program product for performing pre-installation conflict identification and prevention are disclosed. The method includes, in response to determining that a user wants to perform a conflict check for the application for the installation, contacting a remote server over a secure connection across a network and determining whether a problem history exists on the remote server for the identified application. One or more items of relevant information about the data processing system are transmitted to the remote server over the secure connection across the network and pre-installation conflict identification is performed by receiving a percentage risk of an install failure of the installation. The percentage risk of the install failure of the installation is displayed to the user, and, in response to the user indicating a desire to continue an installation in spite of the percentage risk of the install failure of the installation, performing the installation. Conflict prevention is performed by recommending upgrades prior to the installation and installing the upgrades.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 depicts a block diagram of a general-purpose data processing system with which the present invention of a system, method and computer program product for performing pre-installation conflict identification and prevention may be performed; and

FIG. 2 is a high-level logical flowchart of a process for performing pre-installation conflict identification and prevention.

### DETAILED DESCRIPTION OF THE PREFERRED EMBODIMENT

The present invention provides a method, system, and computer program product for performing pre-installation conflict identification and prevention. During the install process, the install program checks pre-requisites (software) to see if a system has the pre-requisite software that meets a set of minimum install requirements. If all minimum pre-requisites are present, then the installer contacts a data server. The installer transmits to the server an OS version with assorted patch and maintenance levels, identities of any third-party software packages, status of any attached or detected hardware devices, and requests an analysis of conflicts.

The server then scans the database for similar or like existing configurations and their associated problems, based on information provided by other users who have experienced problems. A likelihood of failure is reported in the following form: “A check of the problem database has shown that your pre-install configuration with this software matches 89.3% of configurations where others have reported a failure. Would you like to install a known patch or workaround for this problem?” with an opportunity to choose whether to continue installation.

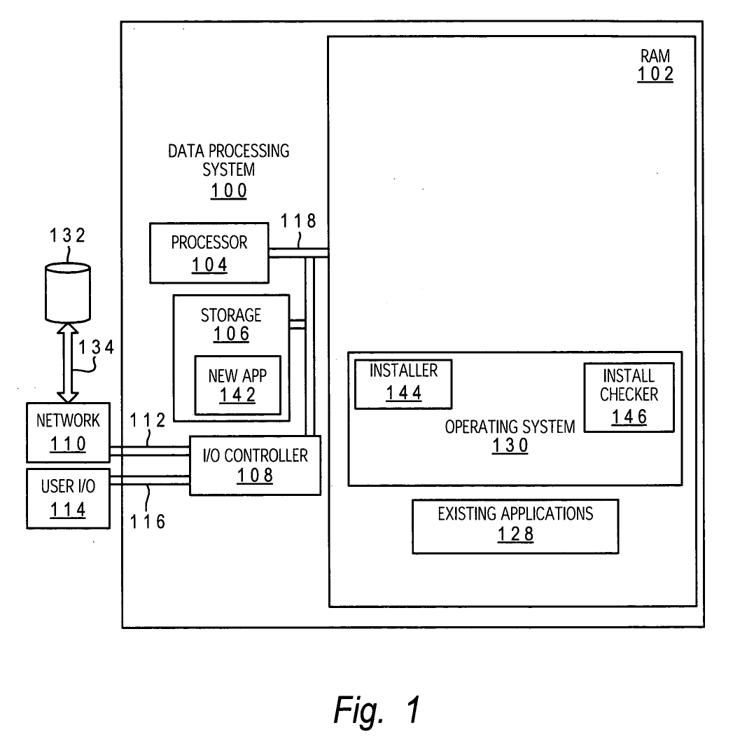

With reference now to the figures, and in particular with reference to FIG. 1, a block diagram of a general-purpose data processing system, in accordance with a preferred embodiment of the present invention, is depicted. Data processing system 100 contains a processing storage unit (e.g., RAM 102) and a processor 104. Data processing system 100 also includes non-volatile storage 106 such as a hard disk drive or other direct-access storage device. A new application 142 is stored in non-volatile storage 106, awaiting installation by an installer 144 within an operating system 130, which is stored in RAM 102. An Input/Output (I/O) controller 108 provides connectivity to a network 110 through a wired or wireless link, such as a network cable 112. Data processing system 100 communicates with a remote server 132 over a secure connection 134 across a network 110. I/O controller 108 also connects to user I/O devices 114 such as a keyboard, a display device, a mouse, or a printer through wired or wireless link 116, such as cables or a radio-frequency connection. System interconnect 118 connects processor 104, RAM 102, storage 106, and I/O controller 108.

Within RAM 102, data processing system 100 stores several items of data and instructions while operating in accordance with a preferred embodiment of the present invention. Existing applications 128 interface with processor 104, RAM 102, I/O control 108, and storage 106 through operating system 130. One skilled in the data processing arts will quickly realize that additional components of data processing system 100 may be added to or substituted for those shown without departing from the scope of the present invention. An install checker 146 in operating system 130 communicates with a remote server 132 over a secure connection 134 across a network 110.

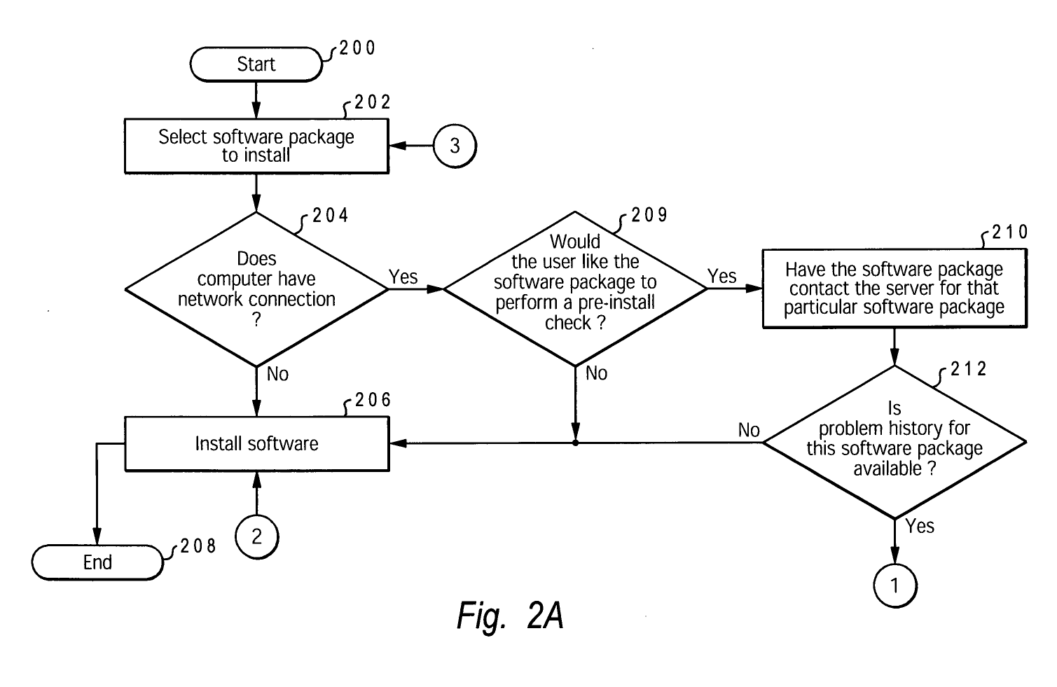

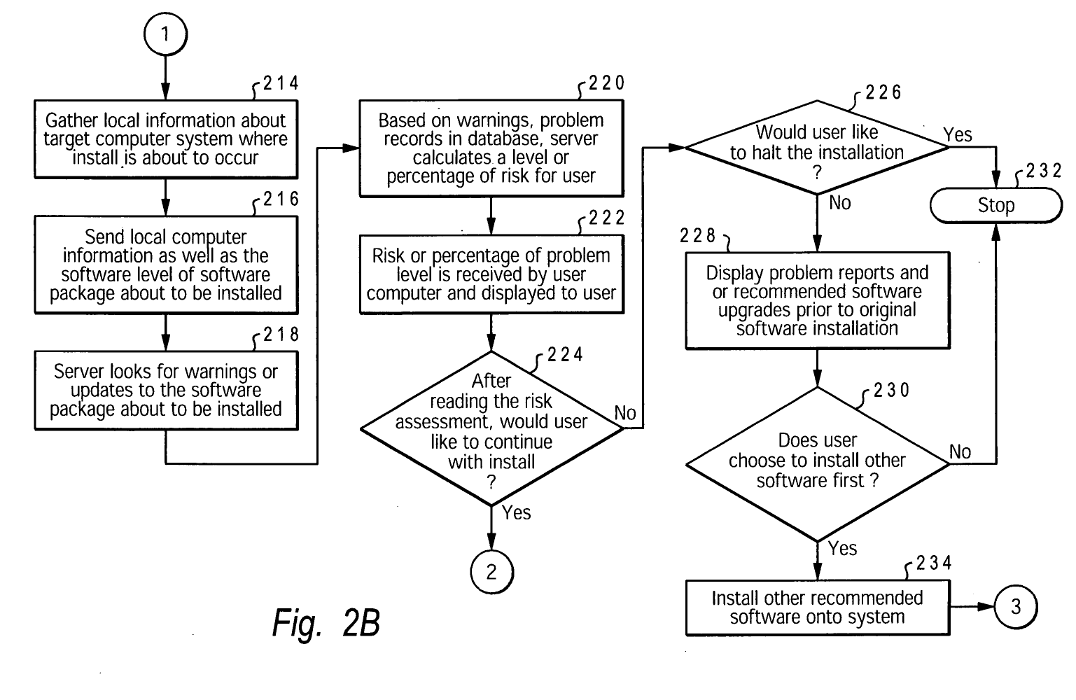

Turning now to FIG. 2, a high-level logical flowchart of a process for performing pre-installation conflict identification and prevention. The process starts at step 200 and then proceeds to step 202, which depicts operating system 130 identifying new application 142 for installation by installer 144. The process next moves to step 204. Step 204 illustrates install checker 146 determining whether data processing system 100 has a connection to network 110. If install checker 146 determines that data processing system 100 does not have a connection to network 110, then the process proceeds to step 206, which depicts installer 144 installing new application 142 on data processing system 100. The process then ends at step 208. By contrast, if install checker 146 determines that data processing system 100 has a connection to network 110, then the process next moves to step 209.

Step 209 illustrates install checker 146 determining, from user input, whether the user of data processing system 100 desires performance by install checker 146 of a pre-install conflict check prior to installation of new application 142 by installer 144. If install checker 146 determines, from user input, that the user of data processing system 100 does not desire performance by install checker 146 of a pre-install conflict check prior to installation of new application 142 by installer 144, then the process returns to step 206, which is described above. However, if install checker 146 determines, from user input, that the user of data processing system 100 desires performance by install checker 146 of a pre-install conflict check prior to installation of new application 142 by installer 144, the process proceeds to step 210, which illustrates install checker 146 contacting remote server 132 across a secure connection 134 over network 110 to inquire as to whether a problem history exists for new application 142. The process next moves to step 212.

Step 212 depicts install checker 146 determining, on the basis of communication from remote server 132 across a secure connection 134 over network 110, whether a problem history exists for new application 142. If install checker 146 determines that no problem history exists for new application 142, then the process returns to step 206, which is described above. However, if install checker 146 determines that a problem history exists for new application 142, then the process proceeds to step 214, which illustrates install checker 146 gathering an OS version with assorted patch and maintenance levels for operating system 130, identities of any third-party software packages within existing applications 128, status of any attached or detected hardware devices, such as user I/O 114. The process next moves to step 216.

Step 216 depicts install checker 146 sending an OS version with assorted patch and maintenance levels for operating system 130, identities of any third-party software packages within existing applications 128, status of any attached or detected hardware devices, such as user I/O 114, a version of new application 142, and a request for a risk assessment to remote server 132 across a secure connection 134 over network 110. The process then proceeds to step 218, which illustrates remote server 132 accumulating warnings or updates related to new application 142. The process next moves to step 220.

Step 220 depicts remote server 132 calculating a percentage risk of install failure based on data accumulated in step 218. The process then proceeds to step 222, which illustrates install checker 146 receiving from remote server 132 across a secure connection 134 over network 110 and displaying to a user through user I/O 114 the percentage risk of install failure calculated at step 220, as well as any relevant warning messages. The process next moves to step 224. Step 224 depicts install checker 146 determining whether, after having read the percentage risk of install failure calculated at step 220, as well as any relevant warning messages, the user wants to continue with the installation by installer 144 of new application 142. If install checker 146 determines that, after having read the percentage risk of install failure calculated at step 220, as well as any relevant warning messages, the user wants to continue with the installation by installer 144 of new application 142, then the process returns to step 206, which is described above.

By contrast, if install checker 146 determines that, after having read the percentage risk of install failure calculated at step 220, as well as any relevant warning messages, the user does not want to continue with the installation by installer 144 of new application 142, then the process next moves to step 226, which depicts install checker 146 determining whether the user wants to halt the installation by installer 144 of new application 142. If install checker 146 determines that the user wants to halt the installation by installer 144 of new application 142, then the process ends at step 232. However, if install checker 146 determines that the user does not want to halt the installation by installer 144 of new application 142, then the process proceeds to step 228. Step 228 illustrates install checker 146 displaying to a user through user I/O 114 the any relevant warning messages and recommendations for additional installations to be performed before the installer 144 installs new application 142.

The process next moves to step 230, which illustrates install checker 146 determining whether the user wants to perform additional installations to be performed before the installer 144 installs new application 142. If install checker 146 determines that the user does not want to perform additional installations to be performed before the installer 144 installs new application 142, then the process ends at step 232. If, however, install checker 146 determines that the user wants to perform additional installations to be performed before the installer 144 installs new application 142, then the process proceeds to step 234. Step 234 illustrates installer 144 performing additional installations to be performed before the installation by installer 144 of new application 142. The process then returns to step 206, which is described above.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for performing pre-installation conflict identification and prevention for an application for an installation on a data processing system, said method comprising:
in response to determining that a user wants to perform a conflict check for said application for said installation, contacting a remote server over a secure connection across a network;
determining whether a problem history exists on said remote server for said identified application;
transmitting one or more items of relevant information about said data processing system to said remote server over said secure connection across said network;
performing pre-installation conflict identification receiving a percentage risk of an install failure of said installation;
displaying to said user said percentage risk of said install failure of said installation;
in response to said user indicating a desire to continue an installation in spite of said percentage risk of said install failure of said installation, performing said installation;
performing conflict prevention by recommending upgrades prior to said installation; and
installing said upgrades.

2. The method of claim 1, further comprising the step of, in response to determining that said data processing system possesses access to said network, determining whether a user wants to perform a conflict check for said application.

3. The method of claim 1, further comprising the step of identifying said application for installation.

4. The method of claim 1, further comprising the step of gathering said one or more items of relevant information about said data processing system.

5. The method of claim 4, wherein said step of gathering said one or more items of relevant information about said data processing system further comprises gathering an operating system version number with one or more patch and maintenance level numbers, identities of one or existing third-party applications, and one or more items of status of any attached or detected hardware devices.

6. The method of claim 1, further comprising the step of said remote server calculating said percentage risk of said install failure.

7. The method of claim 1, further comprising the step of said remote server transmitting said percentage risk of said install failure.

8. A system for performing pre-installation conflict identification and prevention for an application for an installation on a data processing system, said system comprising:
means for, in response to determining that a user wants to perform a conflict check for said application for said installation, contacting a remote server over a secure connection across a network;
means for determining whether a problem history exists on said remote server for said identified application;
means for transmitting one or more items of relevant information about said data processing system to said remote server over said secure connection across said network;
means for performing pre-installation conflict identification receiving a percentage risk of an install failure of said installation;
means for displaying to said user said percentage risk of said install failure of said installation;
means for, in response to said user indicating a desire to continue an installation in spite of said percentage risk of said install failure of said installation, performing said installation;
means for performing conflict prevention by recommending upgrades prior to said installation; and
means for installing said upgrades.

9. The system of claim 8, further comprising means for, in response to determining that said data processing system possesses access to said network, determining whether a user wants to perform a conflict check for said application.

10. The system of claim 8, further comprising means for identifying said application for installation.

11. The system of claim 8, further comprising means for gathering said one or more items of relevant information about said data processing system.

12. The system of claim 11, wherein said means for gathering said one or more items of relevant information about said data processing system further comprises means for gathering an operating system version number with one or more patch and maintenance level numbers, identities of one or existing third-party applications, and one or more items of status of any attached or detected hardware devices.

13. The system of claim 8, further comprising means for said remote server calculating said percentage risk of said install failure.

14. The system of claim 8, further comprising means for said remote server transmitting said percentage risk of said install failure.

15. A machine-readable medium having a plurality of instructions processable by a machine embodied therein, wherein said plurality of instructions, when processed by said machine, causes said machine to perform a machine-readable medium, said method comprising:
in response to determining that a user wants to perform a conflict check for said application for said installation, contacting a remote server over a secure connection across a network;
determining whether a problem history exists on said remote server for said identified application;
transmitting one or more items of relevant information about said data processing system to said remote server over said secure connection across said network;
performing pre-installation conflict identification receiving a percentage risk of an install failure of said installation;
displaying to said user said percentage risk of said install failure of said installation;
in response to said user indicating a desire to continue an installation in spite of said percentage risk of said install failure of said installation, performing said installation;
performing conflict prevention by recommending upgrades prior to said installation; and
installing said upgrades.

16. The machine-readable medium of claim 15, said method further comprising the step of, in response to determining that said data processing system possesses access to said network, determining whether a user wants to perform a conflict check for said application.

17. The machine-readable medium of claim 15, said method further comprising the step of identifying said application for installation.

18. The machine-readable medium of claim 15, said method further comprising the step of gathering said one or more items of relevant information about said data processing system.

19. The machine-readable medium of claim 15, wherein said step of gathering said one or more items of relevant information about said data processing system further comprises gathering an operating system version number with one or more patch and maintenance level numbers, identities of one or existing third-party applications, and one or more items of status of any attached or detected hardware devices.

20. The machine-readable medium of claim 15, said method further comprising the step of said remote server calculating said percentage risk of said install failure.
